(19) United States
(12) Patent Application Publication
(10) Pub. No.: US 2015/0081577 A1
(43) Pub. Date: Mar. 19, 2015

(54) PROFILE MANAGEMENT VIA MULTI-DIMENSIONAL RELATIONSHIP

(71) Applicant: Verizon Patent and Licensing Inc., Basking Ridge, NJ (US)

(72) Inventors: Manah M. Khalil, Coppell, TX (US); Vijaya Ramanaidu Challa, Irving, TX (US); Suraj Nadubettu Kolathaya, Coppell, TX (US); Mohamed Adel Elsabrouty, Dallas, TX (US); Jassem Shakil, Irving, TX (US); Krishnan Rajah, Irving, TX (US); Chinmaya Chunduri, Tenali (IN)

(73) Assignee: Verizon Patent and Licensing Inc., Basking Ridge, NJ (US)

(21) Appl. No.: 14/029,862

(22) Filed: Sep. 18, 2013

(51) Int. Cl. G06Q 10/10

(52) U.S. Cl. CPC G06Q 10/105
USPC 705/320

(57) ABSTRACT

A method, a device, and a non-transitory storage medium having instructions stored thereon provide for the provisioning and management of user profiles of any given system by indicating the identity of the user as a set of properties and properties values rather than indicating the identity of the user by the functions that the user can and cannot do. The method, the device, and the non-transitory storage medium include attribute data that define permissions and non-permissions. A user profile is created based on a configurable mapping of the properties, properties values, and the attribute data. The method, the device, and the non-transitory storage medium allows an end user to create a user profile by selecting properties and properties values, and attributes are automatically linked to such selected properties and properties values.

### BACKGROUND

An organization or a business can include hundreds to thousands of employees. Given the sheer number of employees and the various roles and positions within the organization or the business, the management of profiles of the employees can be cumbersome. As an example, creating a user profile for a new employee can be cumbersome and time-consuming, given the number of facets associated with the new employment, such as main job functions and derivatives thereof.

### BRIEF DESCRIPTION OF THE DRAWINGS

FIG. 1A is a diagram illustrating an exemplary environment in which an exemplary embodiment of a profile manager may be implemented;

FIG. 1B is a diagram illustrating an exemplary process to create a user profile via the profile manager;

FIGS. 2A-2D are diagrams illustrating exemplary graphical user interfaces of the profile manager;

FIG. 3A is a diagram illustrating an exemplary representation of property trees;

FIG. 3B is a diagram illustrating an exemplary mapping between property values and attributes;

FIG. 3C is a diagram illustrating an exemplary user profile;

FIG. 3D is a diagram illustrating an exemplary traversal of a property tree;

FIG. 3E is a diagram of an exemplary profile model that includes a hierarchy of property trees;

FIG. 3F is a diagram illustrating an exemplary process for generating a user profile based on a multidimensional relationship between the hierarchy of property trees, attributes, and the values of the attributes;

FIG. 4 is a diagram illustrating another exemplary graphical user interface of the profile manager;

FIG. 5 is a diagram illustrating exemplary components of a device that may correspond to one or more devices in the environment depicted in FIG. 1A;

FIG. 6 is a flow diagram illustrating an exemplary process to create a user profile using the profile manager; and

FIG. 7 is a diagram illustrating yet another exemplary graphical user interface of the profile manager.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

An organization may create user profiles to assist in the management of the organization. For example, when a person joins the organization, a member of the organization creates a user profile for the new person. In addition to providing basic information (e.g., name, etc.), the creation of the user profile may include assigning numerous permissions or other facets of membership in the organization that enable certain capabilities or job functions. Thus, the creation of the user profile can become very cumbersome and time-consuming, especially as an application that manages user profiles evolves and includes new capabilities and control settings. Additionally, the relationship between one person's profile to another person's profile can be difficult to manage given the dynamic nature of roles within the organization on a day-to-day basis.

According to an exemplary embodiment, a profile manager provides for the creation and management of user profiles. According to an exemplary embodiment, the profile manager creates a user profile based on a profile model. The profile model includes properties attributable to a person. For example, a property identifies a facet or a dimension of the person. By way of further example, a user (e.g., an administrator) of the profile manager may configure the profile model so as to identify a person based on a basic property that includes a name of the person, a member identifier, and communication information (e.g., telephone number, e-mail address, etc.); a position property that indicates the person's position in the organization; a location property that indicates a geographic location where the person works; and a service area property that indicates a geographic area in which the person services. According to an exemplary embodiment, the profile manager allows the properties to be configurable. In this way, a user of the profile manager may, for example, add a property or delete a property to configure the profile model. As a result, the number of properties and the nature of the properties are configurable and may vary depending on the various factors (e.g., diversity of persons for whom the user profiles are created, user discretion, etc.).

According to an exemplary embodiment, each property has one or multiple property values that can be selected and correspond to a facet or dimension of the person for which the user profile is created. For example, a property value of the position property may be an executive secretary or a Chief Financial Officer (CFO). By way of another example, a property value of the location property may be New York, Texas, or California. In this way, when a user creates a user profile via the profile manager, the user selects property values associated with properties that correspond to the user. For example, if the user is creating a user profile of a person that is an executive secretary and works in California, the user would select the property value of executive secretary and the property value of California, which belong to the position property and the location property, respectively.

According to an exemplary embodiment, each property of the profile model is implemented by a tree structure (e.g., a tree hierarchy). For example, a position property tree may include a root node indicating the property (e.g., position), and then leaf nodes indicating various positions (e.g., secretary, manager, call center agent, line technician, etc.). The profile manager may be configured so that the user's selection of property values (e.g., leaf nodes) associated with the trees may define or are representative of the person. That is, the union of selected nodes of multiple trees identifies the person. Accordingly, the properties and the values of the properties may identify the person rather than the attributes (e.g., permissions, functions, etc.,) that are afforded to the person. As described further below, according to an exemplary embodiment, a person inherits attributes which stem from the properties and the values assigned to (e.g., selected by the user when creating the user profile on behalf of the person) the person.

According to an exemplary embodiment, the set of property trees of the profile model may have a hierarchy. For example, a type of employment property tree may have a hierarchical ranking over a location property tree. By way of further example, a type of employment property tree may have a hierarchical ranking over a role property tree, and in turn, the role property tree may have a hierarchical ranking over a location property tree. In this way, a user may create a hierarchy among the property trees themselves.

According to an exemplary embodiment, the profile manager maps the properties and the values of the properties of a person to attributes and its values. According to an exemplary implementation, the attributes include permissions (e.g., what the person can do and can't do) and any other facet associated with the organization (e.g., how much vacation time allotted to the person; the type of uniform worn by the person, etc.). According to an exemplary embodiment, the profile manager allows the attributes and the values of the attributes to be configurable. In this way, a user of the profile manager may, in an administrator role, for example, add an attribute, delete an attribute, add a value for an attribute, etc., and configure the attributes and the possible values of the attributes in a manner best suited for the creation of user profiles.

According to an exemplary embodiment, the profile manager links properties and its values to attributes and its values based on where the property values assigned to the person reside in each of the property trees. For example, the person inherits one or multiple attributes, which each has an attribute value, based on where the person resides in each property tree. The person may obtain all their attributes and values of the attributes based on the union of attributes associated with the node of each tree in which the property values are located. By way of example, assume that a role property tree includes a leaf node of “manager.” An attribute of whether the person can open a store may be linked to the leaf node. The attribute may have two possible values “yes” or “no.” By way of further example, assume, for persons that are managers, such persons inherit the attribute value of “yes” (i.e., a manager can open the store).

According to an exemplary embodiment, profile manager assigns the attributes and its values based on a bottom-to-top traversal of a property tree (i.e., from leaf nodes toward a root node). For example, based on a property tree traversal path, the person inherits attributes and the values of the attributes. Additionally, in the event that a higher node (e.g., a node closer to the root node) includes a same attribute as a lower node (e.g., a node farther from the root node) and has different values, the person is assigned (e.g., inherits) the attribute value of the lower node. Conversely, from a top-to-bottom traversal of a property tree, when no conflict exists between an attribute and a value in relation to a higher node and a lower node, the person inherits the attribute and the value from the higher node, as described further below.

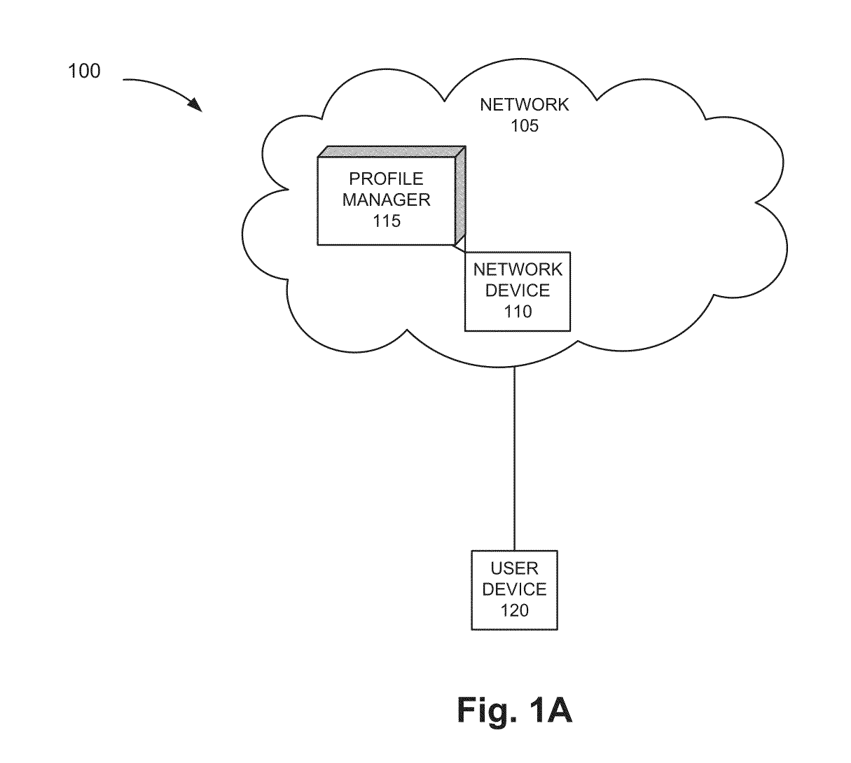

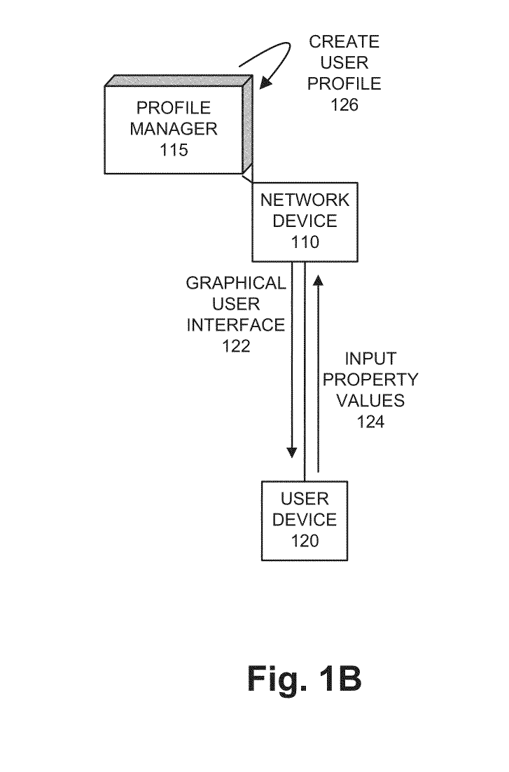

FIG. 1A is a diagram illustrating an exemplary environment 100 in which an exemplary embodiment of the profile manager may be implemented. As illustrated in FIG. 1A, exemplary environment 100 may include a network 105 that includes a network device 110. The network device 110 includes a profile manager 115. Environment 100 also includes a user device 120.

The number of devices and configuration in environment 100 is exemplary and provided for simplicity. According to other embodiments, environment 100 may include additional devices, fewer devices, different devices, and/or differently arranged devices than those illustrated in FIG. 1A. For example, according to other embodiments, there may be multiple network devices 110. Additionally, or alternatively, according to other embodiments, environment 100 may not include network 105 and/or network device 110. For example, user device 120 may include profile manager 115 (e.g., a desktop application). Environment 100 may include wired (e.g., electrical, optical) and/or wireless connections among the devices illustrated.

Network 105 may include one or multiple networks of one or multiple types. For example, network 105 may include the Internet, a wide area network, a private network, a public network, an intranet, a local area network, a packet-switched network, a wired network (e.g., an optical network, a cable network, etc.), a wireless network (e.g., a mobile network, a cellular network, a non-cellular network, etc.), etc. Although not illustrated, network 105 may include various other network devices, such as, one or multiple security devices, routing devices, gateways, access points, etc.

Network device 110 may include a computing device that is capable of hosting profile manager 115. For example, network device 110 may correspond to a server device when implementing an embodiment having a client-server architecture. The server device may take the form of a web server, an application server, a virtual server, or some other type of network server.

Profile manager 115 creates and manages user profiles. According to an exemplary embodiment, profile manager 115 is implemented by software. Profile manager 115 includes a graphical user interface that allows a user to create and manage user profiles. As previously described, according to an exemplary embodiment, profile manager 115 uses configurable properties, configurable property values, and configurable attributes to build a user profile. Profile manager 115 is described further below.

User device 120 includes a device to access and use profile manager 115. For example, user device 120 may be implemented as a computer (e.g., a desktop computer, a laptop computer, a tablet, etc.), a mobile device (e.g., a smartphone, etc.), a Web or Internet user device (e.g., a terminal, etc.) or some other communicative device.

FIG. 1B is a diagram illustrating an exemplary process for creating a user profile via profile manager 115. According to an exemplary scenario, and referring to FIG. 1B, an administrator (not illustrated) wishes to create a new user profile. The administrator launches a client application (e.g., a web browser) and connects to network device 110. The administrator successfully logs in to profile manager 115. Profile manager 115 provides a graphical user interface 122 to allow the administrator to select property values pertaining to properties that identify the user. The administrator selects property values 124 via the graphical user interface 122. Profile manager 115 creates a user profile 126 based on the properties and property values selected by the administrator. The creation of user profile 126 includes profile manager 115 mapping or linking the properties and the values of the properties to attributes and the values of the attributes.

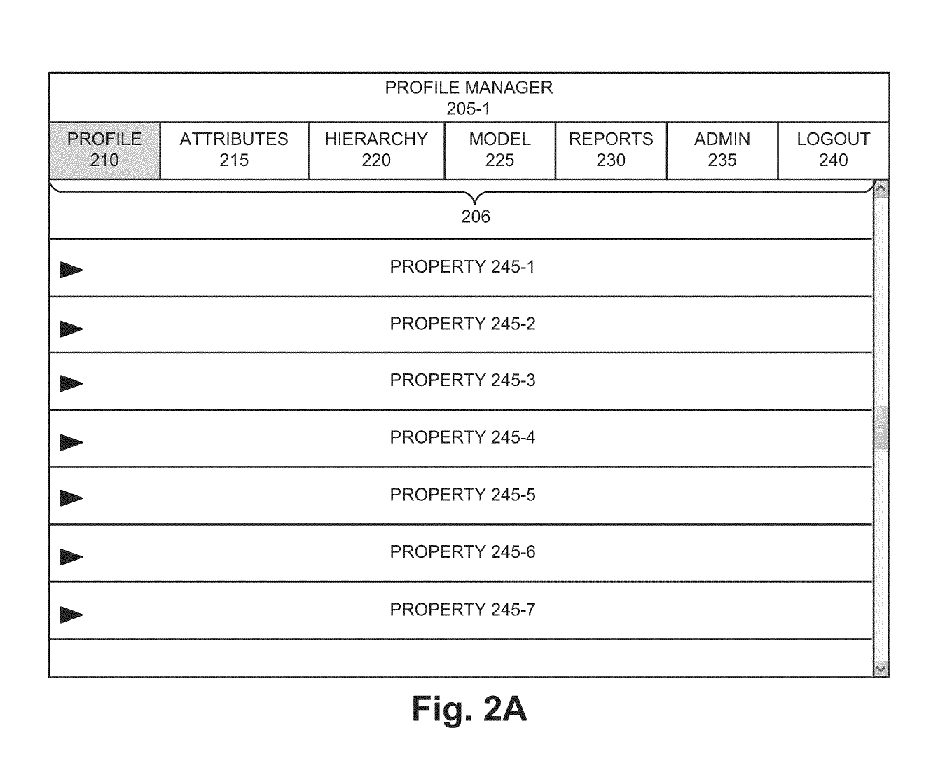

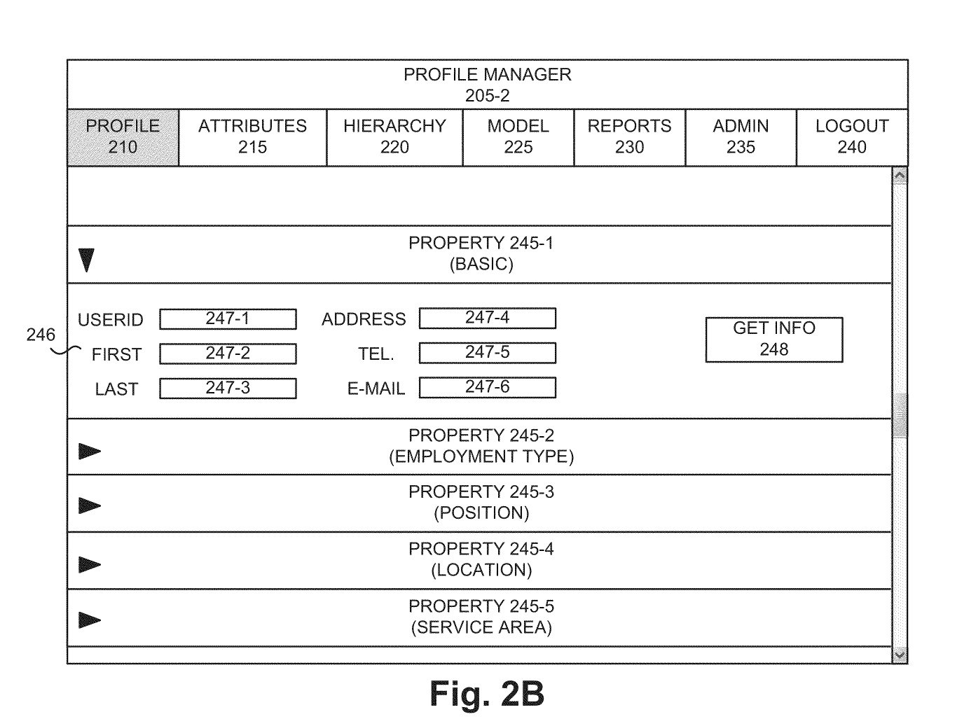

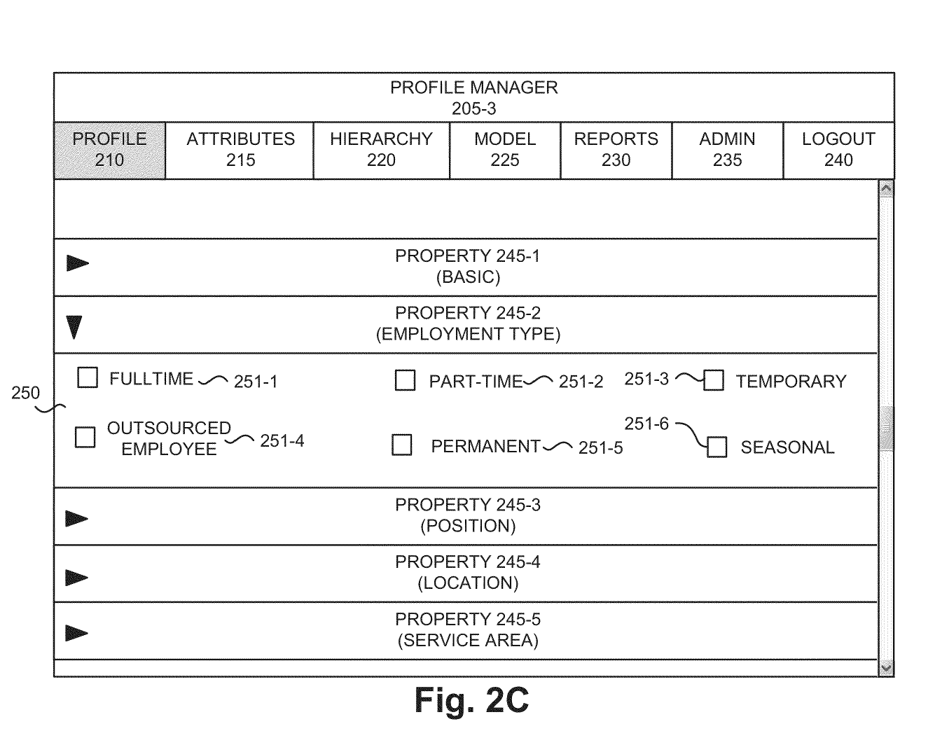

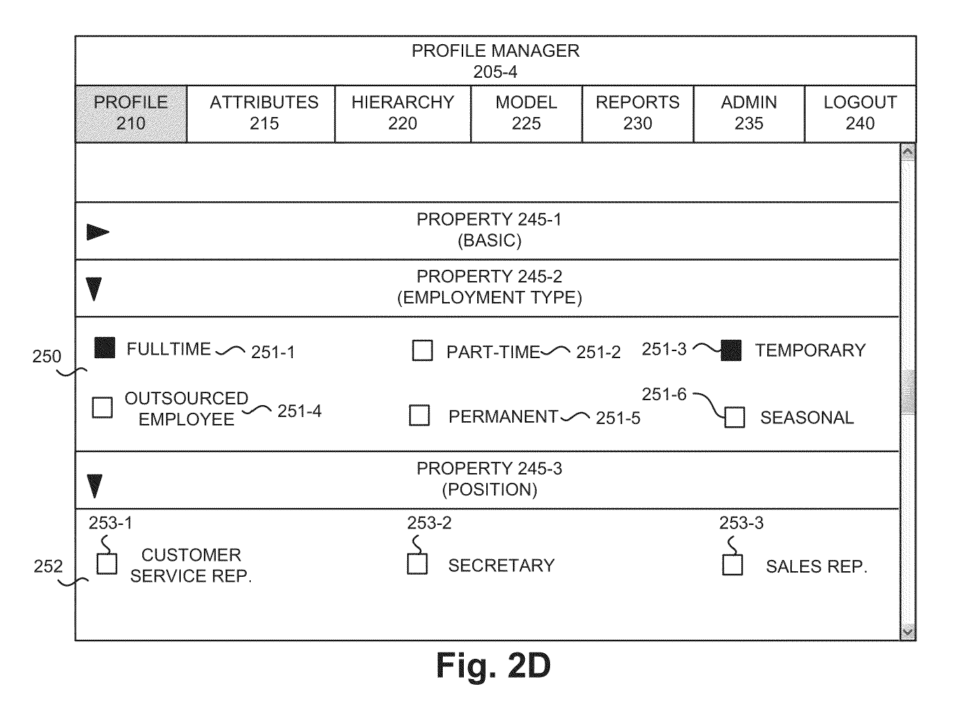

FIGS. 2A-2D are diagrams illustrating exemplary graphical user interfaces of profile manager 115. According to an exemplary embodiment, profile manager 115 includes a graphical user interface 205 (labeled 205-1, 205-2, 205-3, and 205-4 in FIGS. 2A-2D, respectively) that provides various user interfaces to create a user profile, create a property, create a property value, create an attribute, generate a report, as well as other features, as described herein. The graphical elements of graphical user interface 205 described are merely exemplary and may be modified according to other implementations.

Referring to FIG. 2A, a graphical user interface 205-1 includes a menu 206. Menu 206 includes a profile tab 210, an attributes tab 215, a hierarchy tab 220, a model tab 225, a reports tab 230, an administrator tab 235, and a logout tab 240. When profile tab 210 is selected, as illustrated in FIG. 2A, properties that identify a user for which a user profile is to be created may be displayed. According to this example, there are seven properties, which are displayed as properties 245-1 through 245-7 (also referred to collectively as properties 245 or individually/generally as property 245). Profile manager 115 provides these properties 245 to allow a user to select properties and its values to identify the person to whom the user profile pertains. According to other implementations, there may be additional properties or fewer properties. According to an exemplary implementation, each property 245 is interactive to allow the user to input one or multiple property values.

Referring to FIG. 2B, an administrator may enter property values via graphical user interface 205-2. As an example, assume that property 245-1 is named as a basic property; property 245-2 is named as an employment type property; property 245-3 is named as a position property; property 245-4 is named as a location property; and property 245-5 is named as a service area property. As further illustrated, assume that an administrator selected property 245-1 and a graphical user interface portion 246 appears that allows the administrator to enter property values pertaining to the basic property. According to an exemplary scenario, the administrator may select a get info button 248 that causes one or more of the property value fields 247-1 through 247-6 to become populated with property values. For example, profile manager 115 may retrieve property values from a human resource database (not illustrated) in response to activating get info button 248.

Referring to FIG. 2C, assume the administrator selects property 245-2 (employment type) from a graphical user interface 205-3. In this example, the administrator may select property values pertaining to the employment type via graphical user interface portion 250. As illustrated, the exemplary property values 251-1 through 251-6 (also referred to collectively as property values 251) include fulltime, part-time, temporary, outsource employee, permanent, and seasonal. The user may select one or multiple property values 251 (e.g., fulltime or fulltime, temporary, etc.).

Referring to FIG. 2D, assume that the user selects property values 251-1 (full time) and 251-3 (temporary) via a graphical user interface 205-4. The user then selects property 245-3 (position) and a graphical user interface portion 252 appears that allows the user to select exemplary property values 253-1 through 253-3 (also referred to collectively as property values 253). According to an exemplary embodiment, property values 253 have a dependency link to property 245-2 and the selected property values 251-1 and 251-3. That is, in this example, the only positions that are fulltime and temporary are a customer service representative, a secretary, and a sale representative. In this way, the user is assured that any of the selected property values 253 will be valid. As described further below, model tab 225 allows an administrator to configure the dependencies of properties and its values.

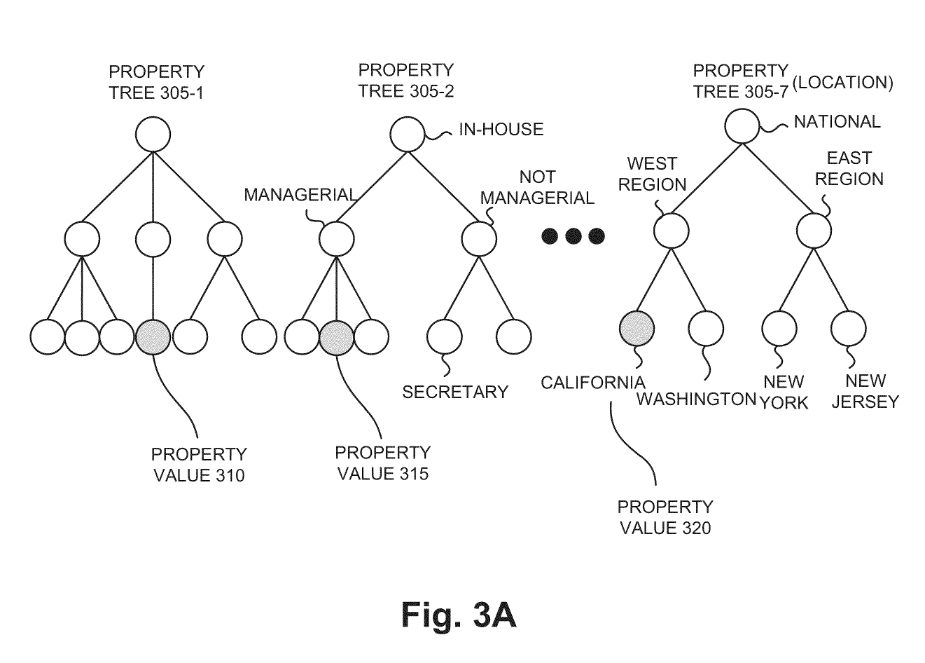

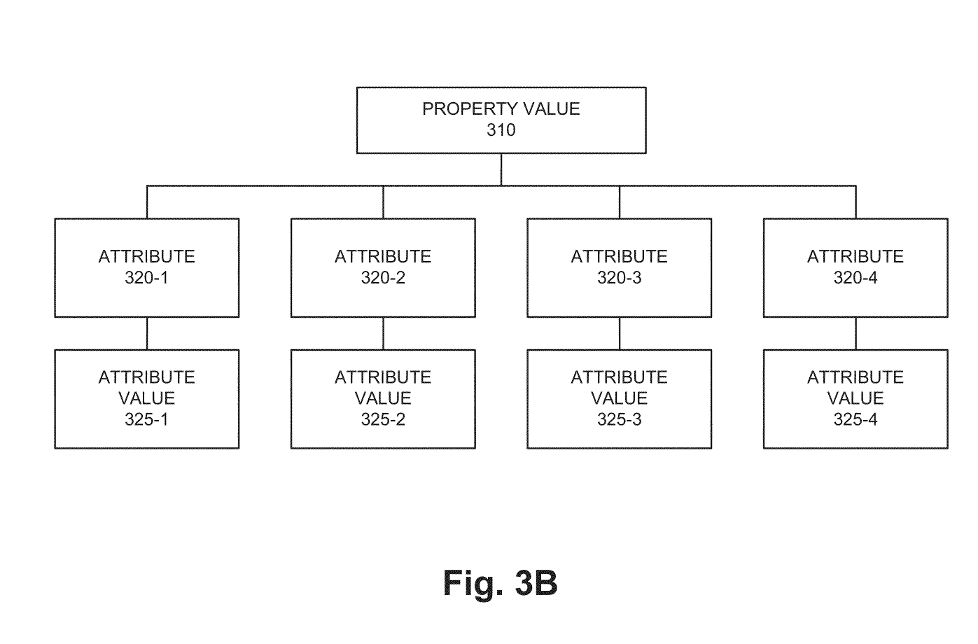

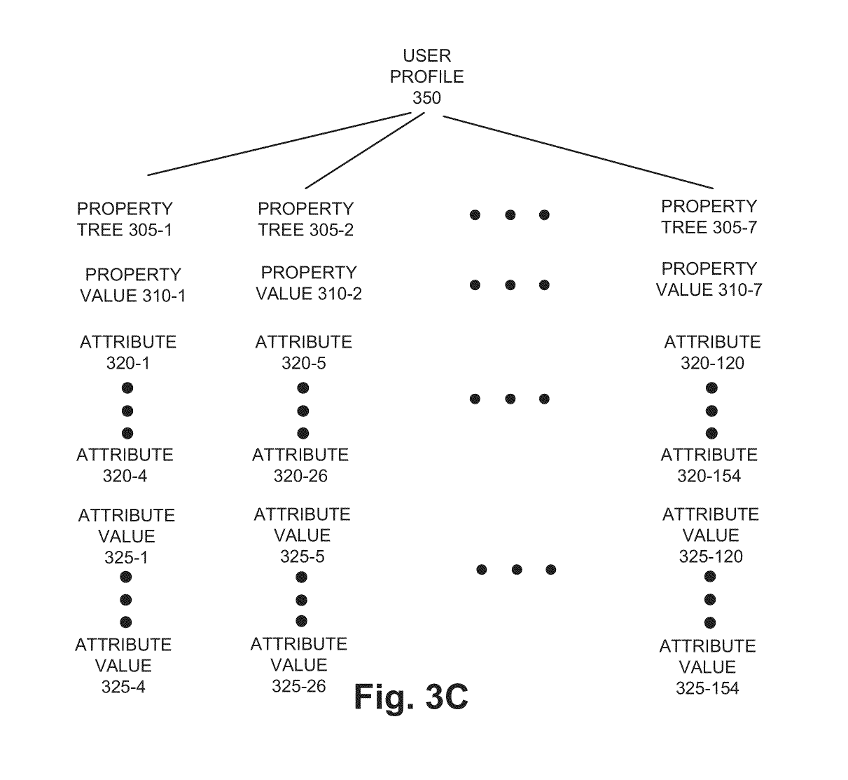

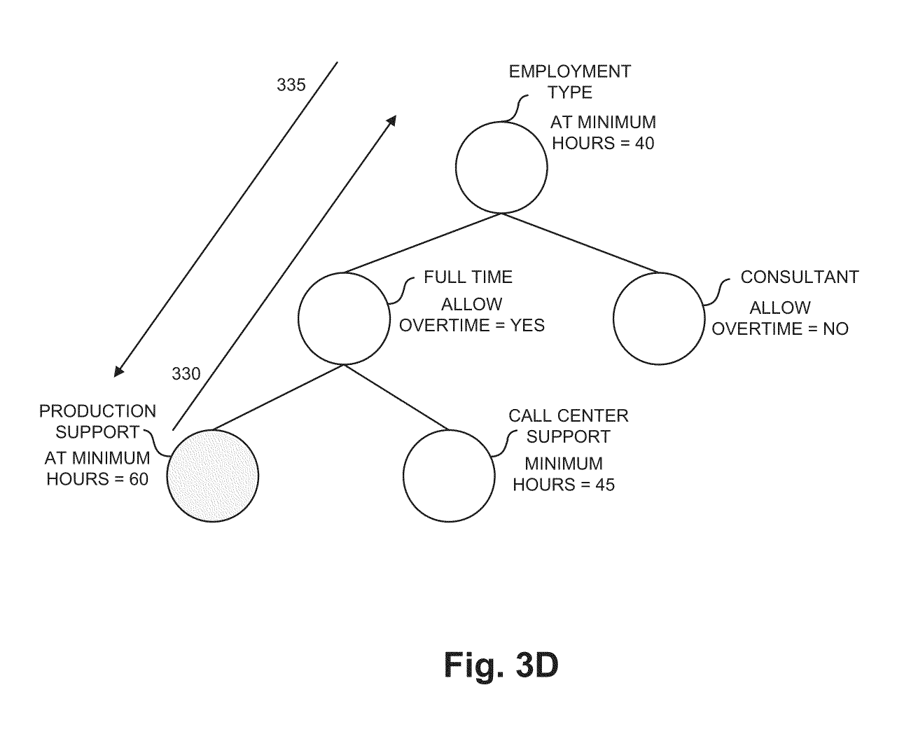

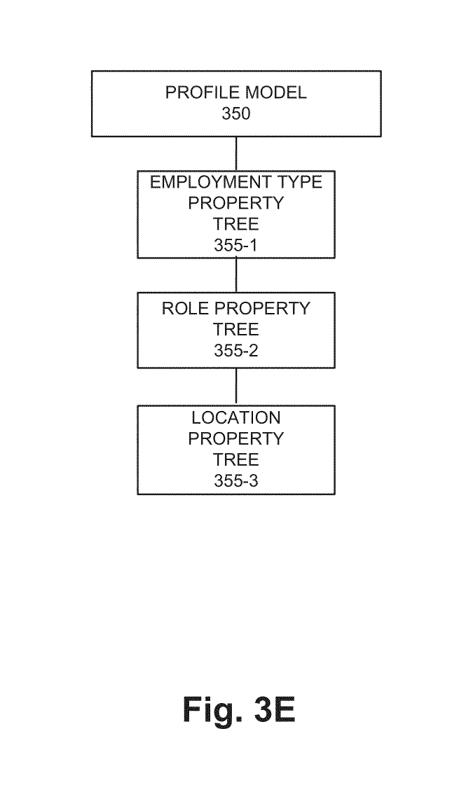

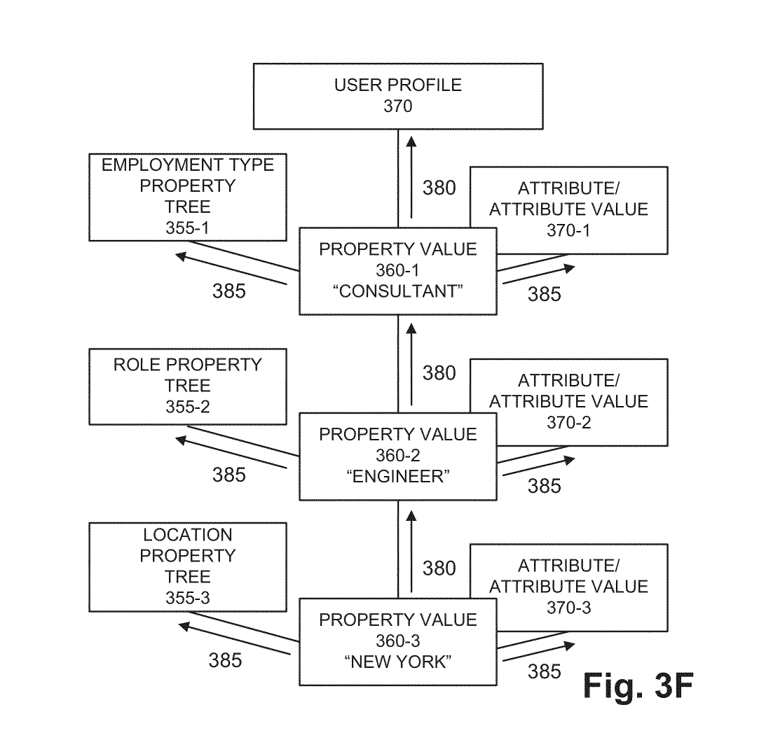

FIG. 3A is a diagram illustrating an exemplary representation of property trees that may be implemented by an exemplary embodiment of profile manager 115. The number of nodes in each property tree, the number of tiers of each property tree, and the branches in each property tree are merely exemplary. In reference to the graphical user interfaces 205 previously described, the administrator may select a property value for each property 245.

Referring to FIG. 3A, property trees 305-1 through 305-7 (also referred to collectively as property trees 305) may correspond to properties 245 and the property values selected correspond to a node (e.g., property values 310, 315, 320) in each property tree 305. As an example, referring to property tree 305-2, assume that property tree 305-2 pertains to the property of position or role within a business. Property tree 305-2 includes nodes having property values, such as, for example, in-house, managerial, non-managerial, etc. The nodes below managerial and non-managerial may further specify a particular position which has a particular property value, such as high-level manager, mid-level manager, secretary, call center agent, security officer, etc. According to such a position tree, the positions or roles indicated by the nodes of property tree 305-2 may be configured in a hierarchical manner starting from the root node (e.g., in-house) toward the leaf nodes (e.g., managerial, secretary, etc.).

Additionally, referring to property tree 305-7, the property (location) is hierarchical in nature. For example, the nodes of property tree 305-7 include national, east region, west region, New Jersey, New York, Washington, and California. The property of “location” can assume any value (e.g., location=west region or location=California).

FIG. 3B is a diagram illustrating an exemplary mapping between a property value and attributes. As previously described, profile manager 115 links one or multiple attributes to a property value. By way of example, as illustrated in FIG. 3B, profile manager 115 links property value 310 of property tree 305-1 to attributes 320-1 through 320-4 (also referred to collectively as attributes 320) and the values of attributes 325-1 through 325-4 (also referred to collectively as values of attributes 325). Attributes 320 may include permissions (e.g., what the person can do and can't do) and/or any other facet associated with the business (e.g., salary for the person, term of employment, amount of vacation, benefits available, access to a building, who their boss is, etc.).

As illustrated in FIG. 3C, a user profile 350 is defined by the union of properties, the values of the properties, attributes, and the values of the attributes. For example, as previously described, property trees 305-1 through 305-7 and the values 310-1 through 310-7 may identify a person. Additionally, attributes 320-1 through 320-154 and the values 325-1 through 325-154 may be assigned to the person based on a linking between property trees 305/values 310 and attributes 320/values 325. The number of attributes and the values of the attributes, the linking, the number of properties, the values of the properties, etc., are exemplary.

FIG. 3D is a diagram illustrating an exemplary process for generating a user profile of a person based on an exemplary property tree. Referring to FIG. 3D, assume that the property tree is of an employment type. For example, the root node indicates “employment type” and has an attribute of “at minimum hours” with an attribute value of “40.” A first lower level tier of leaf nodes includes one leaf node with a property value of “full time” having an attribute of “allow overtime” and an attribute value of “yes” and another leaf node with a property value of “consultant” having the attribute of “allow overtime” and an attribute value of “no.” Additionally, a second lower level tier of leaf nodes that branch from the parent leaf node of “fulltime” includes one leaf node with a property value of “production support” having an attribute of “minimum hours” and an attribute value of “60” and another leaf node having a property value of “call center support” having an attribute of “minimum hours” and an attribute value of “45.”

According to an exemplary process, the generating of the user profile is based on a bottom-to-top traversal of the property tree. For example, assume that the person has an employment type of “production support.” A bottom-to-top traversal path 330 includes a traversal of the property tree from the leaf node of “production support” to the root node of “employment type.” Profile manager 115 collects the attributes of nodes along the bottom-to-top traversal path 330. For example, a person identified as “production support” would be assigned the attribute of “minimum hours” and the attribute value of “60. Continuing with the bottom-to-top traversal 330, the person would be assigned the attribute of “allow overtime” and the attribute value of “yes.” Additionally, the attribute of “at minimum hours” of the root node has already been assigned, so the attribute value of “40” would be overridden by the leaf node of “production support.”

Additionally, the exemplary process includes a top-to-bottom attribute and attribute value assignment based on inheritance. For example, profile manager 115 collects attributes of nodes along a top-to-bottom traversal path 330. For example, assume a person is identified as a “consultant.” The person would be assigned the attribute of “at minimum hours” and the attribute value of “40.” Additionally, the “consultant” is linked to the attribute of “allow overtime” and the attribute value of “no.”

FIG. 3E is a diagram of an exemplary profile model that includes a hierarchy of property trees. As illustrated, profile model 350 includes a hierarchical arrangement of property trees 355-1 through 355-3 (also referred to collectively as property trees 355). Property tree 355-1 pertains to the property of “employment type”; property tree 355-2 pertains to the property of “role”; and property tree 355-3 pertains to the property of “location.” For the sake of this example, property trees 355 include property values that can be used to identify a person when generating a user profile.

FIG. 3F is a diagram illustrating an exemplary process for generating a user profile based on a multidimensional relationship between the hierarchy of property trees, which include properties and the values of the properties, attributes, and the values of the attributes. Profile manager 115 generates a user profile 370 based on the selection of property values 360-1 through 360-3 (also referred to as property values 360) belonging to property trees 355. According to this example, the user identifies a person to whom user profile 370 pertains, via profile manager 115, by selecting an employment type of property value 360-1 (“consultant”), a role type of property value 360-2 (“engineer”), and a location type of property value 360-3 (“New York”). Profile manager 115 assigns attributes/attributes values 370-1 through 370-3 (also referred to as attributes/attributes values 370) that are linked to property values 360. Profile manager 115 also traverses other nodes leading to the root node in each of property trees 355, as previously described in relation to FIG. 3D. In this way, profile manager 115 collects other attributes and the values of the attributes associated with each node along a bottom-to-top traversal path and by way of inheritance.

According to an exemplary embodiment, the overriding of an attribute and an attribute value assigned to a lower level node of a property tree relative to a higher level node, as previously described, may extend between property trees. For example, an attribute and an attribute value associated with a node of location property tree 355-3 overrides the same attribute and a different attribute value associated with a node of role property tree 355-2 and a node of employment type property tree 355-1. According to another embodiment, the reverse may be true in which the node of a property tree 355 that is higher in the hierarchical ranking of property trees 355 may override the attribute value of the node of a property tree 355 that is lower in the hierarchical ranking.

For purposes of illustration, FIG. 3F includes arrows 380 and arrows 385. Arrows 380 signify a first dimensional traversal of the hierarchical tree structure that includes property trees 360. Arrows 385 signify a second dimensional traversal to obtain the attributes and the values of the attributes associated with nodes along the traversal path of each property tree 360. In this way, arrows 380 provide a traversal path that generates an identity sub-profile of user profile 370 and arrows 385 provide a traversal path that generates a functional sub-profile of use profile 370. That is, the properties and the values of the properties selected that pertain to the person identify the person and the attributes and the values of the attributes that are linked to the properties and the values of the properties provide a functional makeup of the person. The linking of properties, the values of properties, attributes, and the value of attributes, which is described as a multidimensional relationship, may be implemented using pointers or other suitable objects, functions, etc.

The task of who can assign a property value to a property versus who can map attributes to properties and assign attribute values to attributes for certain property values are usually assigned different user roles. For example, an administrator of the system may be expected to create a one-time mapping of attributes to properties. A supervisor or a manager (e.g., an end user of the system) may be expected to create user profiles and assign property values to the limited properties set. According to this example, the role of the end user (e.g., the supervisor or the manager) would be to define the identity of the user while the role of the administrator, through the attribute mapping process, would be to define what the identity definition would allow its users to have as capabilities.

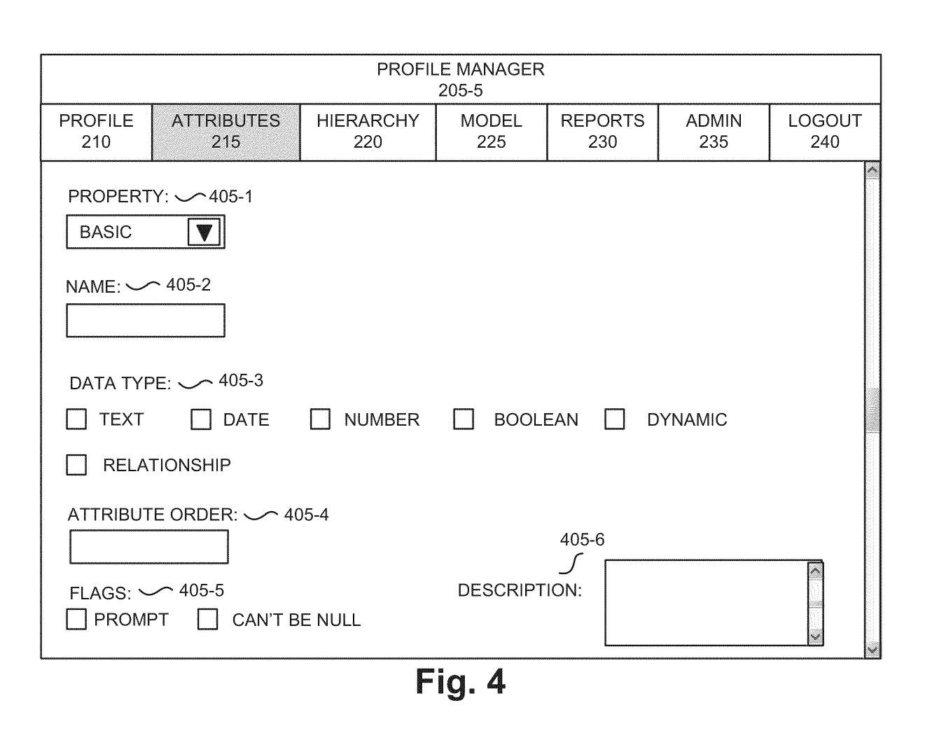

FIG. 4 is a diagram illustrating an exemplary graphical user interface of the profile manager. As illustrated, a graphical user interface 205-5 may be displayed by profile manager 115 when the administrator selects attributes tab 215. Graphical user interface 205-5 allows the administrator to configure an attribute. For example, an administrator may select a property 405-1 to which an attribute is assigned. Additionally, a name 405-2 allows the administrator to name the attribute. A data type 405-3 allows the administrator to select a data type for the attribute, such as text, date, number, Boolean, dynamic, and relationship. An attribute order 405-4 allows the administrator to identify an order of an attribute in relation to other attributes. For example, if profile manager 115 uses one hundred sixty attributes, the administrator may indicate a numerical order (e.g., fifteen) of an attribute. Flags 405-5 allow the administrator to indicate whether the value of an attribute is common to all users who are assigned a property value that maps to this attribute or whether the value of the attribute is unique (e.g., per user) and supplied by an end user (e.g., a supervisor or a manager) at the time the user profile is created, in which case the attribute value is provided along with the values of the properties in the profile definition. In addition, this section allows the administrator to define whether an attribute value, which is designated to be supplied at the time the user profile is created, is to have an empty or null value. Description 405-6 allows the administrator to describe or define the attribute. For example, the administrator may describe the attribute in text or define the attribute in the form of code or a formula.

Although not illustrated, profile manager 115 includes other graphical user interfaces pertaining to hierarchy tab 220, model tab 225, reports tab 230, administrator tab 235, and logout tab 240. For example, when hierarchy tab 220 is selected, profile manager 115 provides a graphical user interface that allows an administrator to configure multiple hierarchies that pertain to relationships between members of the organization. For example, an individual may have a supervisor that has the authority to decide an issue or govern the individual with respect to one facet of employment while another supervisor has authority to decide an issue or govern the individual with respect to another facet of employment. By way of further example, an individual may have one supervisor that approves vacation time and another supervisor that can approve a credit to a customer account. In an organization, additional complexities can be introduced if, for example, the individual's supervisor for a given facet changes on a day-to-day basis and/or on a shift-by-shift basis. According to an exemplary embodiment, profile manager 115 allows an administrator to map a user profile to other user profiles for a given context (e.g., facet). In this regard, an individual (e.g., a manager, etc.) may be assigned certain attributes that correspond to roles, powers, etc., pertaining to other individuals. According to an exemplary embodiment, profile manager 115 creates trees between user profiles in which each tree may be context specific. Profile manager 115 allows an administrator or any other type of user to query or search for another individual in the given context.

When model tab 225 is selected, profile manager 115 provides a graphical user interface that allows an administrator to create properties, the property values, and any dependency between properties. For example, a dependency or a linking between properties may take the form of the example previously described and illustrated in relation to FIG. 2D. That is, the selection of a property value with respect to a property has a dependency or a link to another property and property value. When reports tab 230 is selected, profile manager 115 provides a graphical user interface that allows an administrator to create various reports pertaining to user profiles. When administrator tab 235 is selected, profile manager 115 provides a graphical user interface that allows an administrator to configure profile manager 115. When logout tab 240 is selected, profile manager 115 provides a graphical user interface that allows an administrator to logout of profile manager 115.

According to an exemplary embodiment, profile manager 115 includes various usage levels. For example, profile manager 115 may allow some users to create and delete user profiles, while other users may be only able to view user profiles. By way of further example, profile manager 115 may allow some users to create properties, property values, and attributes. According to an exemplary implementation, the scope of usage of profile manager 115 may be based on an individual's user profile. In this way, profile manager 115 provides security features that are built on profile manager 115.

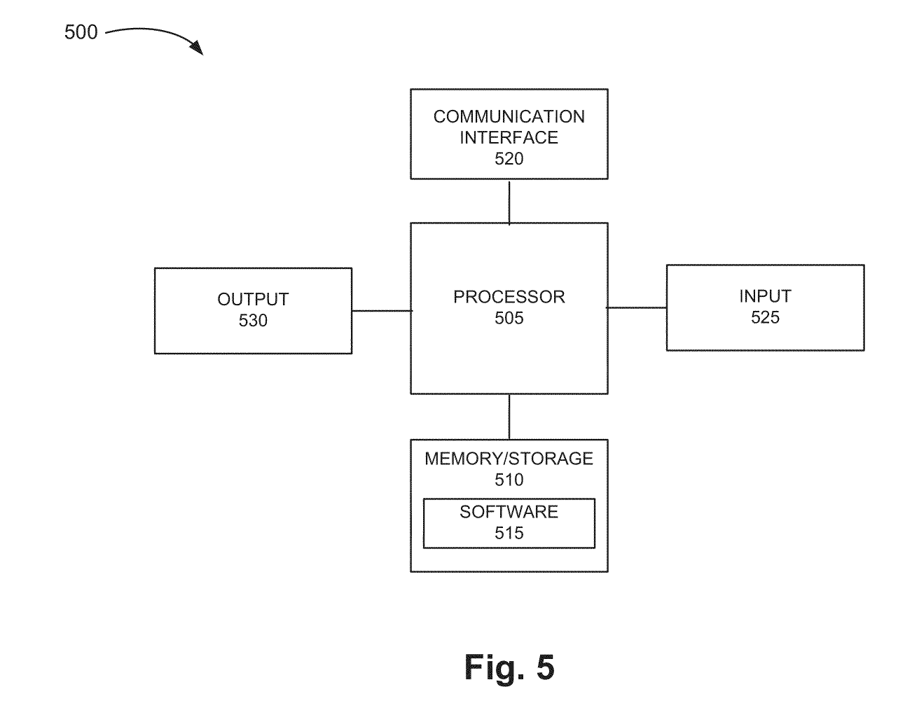

FIG. 5 is a diagram illustrating exemplary components of a device 500 that may correspond to one or more of the devices in environment 100. For example, device 500 may correspond to components included in user device 120 or other device(s) that may be used in a streaming process. As illustrated, device 500 includes a processor 505, a memory/storage 510 that stores software 515, a communication interface 520, an input 525, and an output 530. According to other implementations, device 500 may include fewer components, additional components, different components, and/or a different arrangement of components than those illustrated in FIG. 5 and described herein.

Processor 505 includes one or multiple processors, microprocessors, data processors, co-processors, multi-core processors, application specific integrated circuits (ASICs), controllers, programmable logic devices, chipsets, field programmable gate arrays (FPGAs), system on chips (SoCs), programmable logic devices (PLSs), microcontrollers, application specific instruction-set processors (ASIPs), central processing units (CPUs), or some other component that interprets and/or executes instructions and/or data. Processor 505 may be implemented as hardware (e.g., a microprocessor, etc.) or a combination of hardware and software (e.g., a SoC, an ASIC, etc.). Processor 505 may include one or multiple memories (e.g., memory/storage 510), etc.

Processor 505 may control the overall operation, or a portion of operation(s) performed by device 500. Processor 505 may perform one or multiple operations based on an operating system and/or various applications or programs (e.g., software 515). Processor 505 may access instructions from memory/storage 510, from other components of device 500, and/or from a source external to device 500 (e.g., another device, a network, etc.).

Memory/storage 510 includes one or multiple memories and/or one or multiple other types of storage mediums. For example, memory/storage 510 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory, and/or some other type of memory. Memory/storage 510 may include a hard disk (e.g., a magnetic disk, an optical disk, a magneto-optic disk, a solid state disk, etc.) and a corresponding drive. Memory/storage 510 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 510 may include drives for reading from and writing to the storage medium.

Memory/storage 510 may be external to and/or removable from device 500, such as, for example, a Universal Serial Bus (USB) memory stick, a dongle, a hard disk, mass storage, off-line storage, or some other type of storage medium (e.g., a compact disk (CD), a digital versatile disk (DVD), a Blu-Ray® disk (BD), etc.). Memory/storage 510 may store data, software, and/or instructions related to the operation of device 500

Software 515 includes an application or a program that provides a function and/or a process. Software 515 may include firmware. For example, with reference to user device 120, software 515 may include an application that, when executed by processor 505, provides the functions of profile manager 115, as described herein.

Communication interface 520 permits device 500 to communicate with other devices, networks, systems and/or the like. Communication interface 520 includes one or multiple wireless interface(s) and/or wired interface(s). For example, communication interface 520 may include one or multiple transmitter(s) and receiver(s), or transceiver(s).

Input 525 provides an input into device 500. For example, input 525 may include a keyboard, a keypad, a touchscreen, a touch pad, a touchless screen, a mouse, an input port, a button, a switch, a microphone, a knob, and/or some other type of input.

Output 530 provides an output from device 500. For example, output 530 may include a display, a speaker, a light (e.g., light emitting diode(s), etc.), an output port, a vibratory mechanism, and/or some other type of output.

Device 500 may perform a function or a process in response to processor 505 executing software instructions stored by memory/storage 510. For example, the software instructions may be read into memory/storage 510 from another memory/storage 510 or read from another device via communication interface 520. The software instructions stored in memory/storage 510 may cause processor 505 to perform processes described herein. Alternatively, according to another implementation, device 500 may perform a process or a function based on the execution of hardware (e.g., processor 505, etc.).

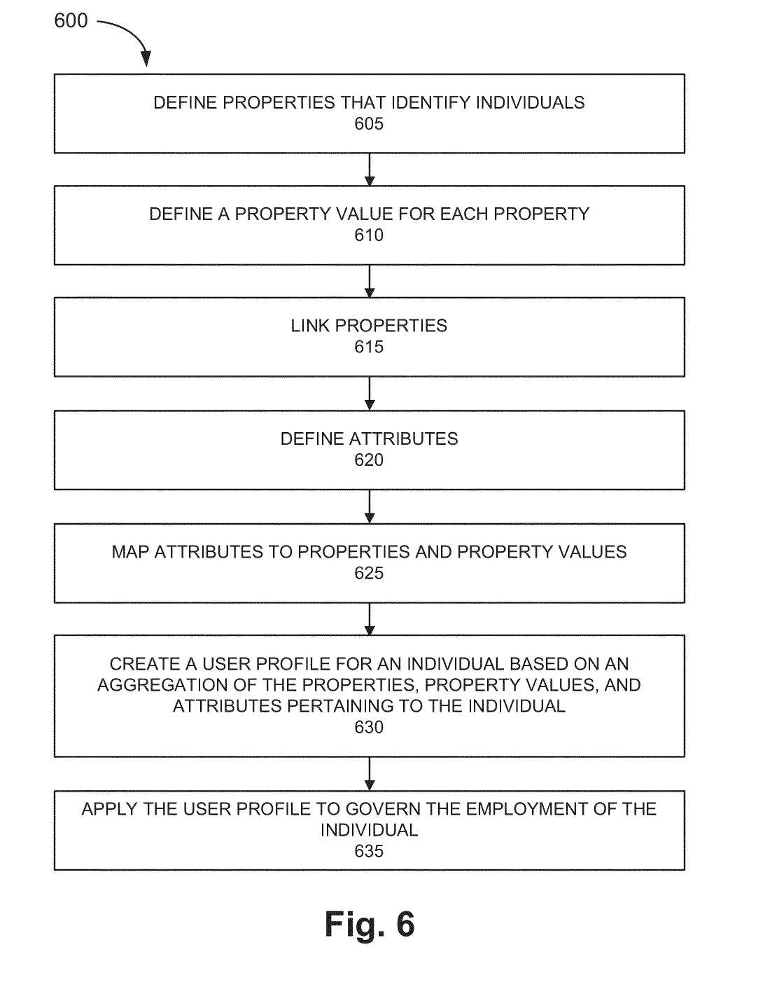

FIG. 6 is a flow diagram illustrating an exemplary process 600 to create a user profile. According to an exemplary embodiment, one or more operations of process 600 are performed by profile manager 115. For example, the functionality of profile manager 115 may be implemented as processor 505 executing software 515.

Process 600 may begin, in block 605, with defining properties that identify individuals. For example, profile manager 115 receives properties that identify individuals of an organization. For example, a property may include a shared characteristic among individuals. By way of example, as previously described, a property may include an employment type, a position, a location, etc.

In block 610, a property value for each property is defined. For example, profile manager 115 receives one or multiple property values pertaining to a property. By way of example, a location property may include property values corresponding to various locations of a business (e.g., Pittsfield, Ma; New Haven, Conn., a street address, a building number, a room, etc.).

In block 615, properties are linked. For example, profile manager 115 receives a link between a property/property value pair and another property/property value pair. By way of example, the position of an individual may be dependent on the location at which an individual works. This allows creating cross-properties/property values validation in which a property can only assume specific values if another property has a specific value selected. This process is referred to as property linking.

In block 620, attributes are defined. For example, profile manager 115 receives attributes. As previously described, an attribute may be a facet of an organization, such as a permission or other variable pertaining to the organization. Attributes mapping is a function, which may be handled by a user with an administrator role, and may be done a single time for any given profile model.

In block 625, attributes are mapped to properties and property values. For example, profile manager 115 receives a mapping of attributes to the properties and property values. By way of example, an individual, whose “job” property value is a “security guard,” may be assigned an attribute that has full access to any room in a building or a facility. According to another example, an individual, whose “job” property value is a “full-time manager” at a facility in Irving, Tex. has two free meals per week in a cafeteria. In this latter example, the identity of the user is defined through three properties, namely, Job Type, Job Role, and Location (e.g., Job Type=full-time, Job Role=Manager, Location=Irving, Tex.). The attribute of “free meals per week” will assume (e.g., through mapping) the value three for this set of properties/properties values.

In block 630, a user profile for an individual is created based on an aggregation of the properties, property values, and attributes pertaining to the individual. For example, profile manager 115 receives a selection of property values associated with the properties, as previously described in relation to FIGS. 2A-2D. Based on the selections of properties and property values, profile manager 115 assigns the attributes and its values that are linked to the selections, and creates a user profile, as previously described in relation to FIGS. 3A-3F.

In block 635, the user profile is applied to govern the employment of the individual. For example, assume that the individual is a customer service representative, the individual's computer may operate (e.g., access to particular applications, functions available within the applications, etc.) based on the user profile. Additionally, for example, other facets of the individual's employment may be governed based on the user profile (e.g., pay, sick time, vacation time, etc.), which may be used by various other departments (e.g., human resources, accounting, etc.), systems (e.g., a security system that governs access to a room using a passkey), etc.

Although FIG. 6 illustrates an exemplary process 600, according to other implementations, process 600 may include additional operations, fewer operations, and/or different operations than those illustrated in FIG. 6, and described herein. For example, profile manager 115 may communicate a user profile to other devices (e.g., computers, security system, etc.) associated with a place of employment. The other devices may operate based on the user profile. For example, an accounting system may credit a person's paycheck with sick time based on the user profile or a security system may allow a person to enter a building based on the user profile. Alternatively, the user profile may be used by personnel to make decisions regarding the day-to-day activities pertaining to the person and applicable to their employment.

According to an exemplary embodiment, profile manager 115 provides for attributes and the values of the attributes associated with a user profile to be inherited by another user profile. This feature can be particularly useful when, for example, there are temporary re-assignments of personnel or when personnel may be handling multiple positions. In these cases, the administrator may be spared the task of recreating profiles by allowing the administrator to have a user profile simply “inherit” the attributes of another user profile.

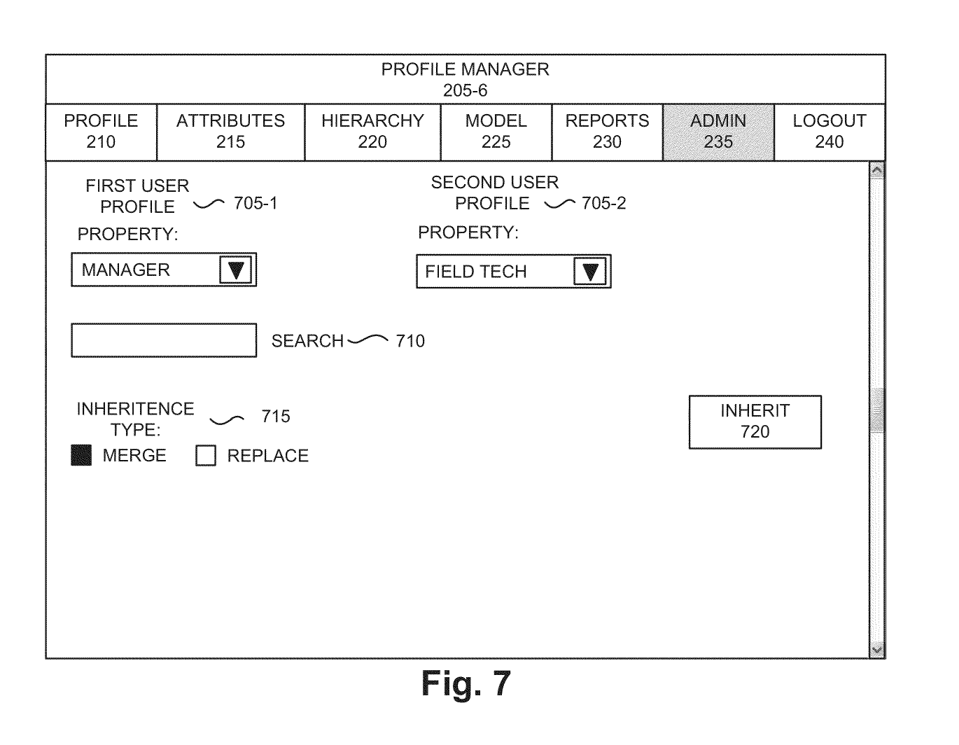

FIG. 7 is a diagram illustrating an exemplary graphical user interface 205-6 of profile manager 115. According to this example, graphical user interface 205-6 is accessed via a selection of the administrator tab 235. As illustrated, graphical user interface 205-6 indicates a first user profile 705-1 and a second user profile 705-2. First user profile 705-1 relates to the user profile(s) that are to be modified. Second user profile 705-2 relates to the user profile(s) from which attributes are to be inherited.

According to an exemplary embodiment, one or multiple user profiles may be identified based on the selection of one or multiple properties. According to this example, assume the administrator wants to merge the attributes of a manager with the attributes of a field technician. While one property (e.g., a position property) is illustrated to identify a property of first user profile 705-1 (e.g., a manager) and a property of second user profile 705-2 (e.g., field technician), according to other implementations of graphical user interface 205-6, multiple properties may be selected (e.g., location and position; part-time, position, location; etc.). By way of example, a graphical user interface similar to graphical user interface 205-2 may be used to allow the administrator to select one or multiple properties and select one or multiple property values. Profile manager 115 may then retrieve user profiles possessing the selected property/property values. The administrator may be able to retrieve the user profiles for both first user profile 705-1 and second user profile 705-2 in this manner. In this way, the administrator has the utmost flexibility in selecting which user profiles to use.

Referring back to FIG. 7, according to this example, profile manager 115 can specify that all of the managers inherit the attributes and the values of the attributes of the field technician. In this way, an administrator may not have to individually select each user profile of individuals that are managers. Graphical user interface 205-6 also includes a search field 710 that allows the user to search (e.g., by name, organization identifier, etc.) for an individual and retrieve a user profile that may be selected to inherit attributes.

As further illustrated, graphical user interface 205-6 includes an inheritance type 715. According to an exemplary implementation, there are two types of inheritance: a merge type and a replacement type. The merge type provides for the merging of attributes. For example, the individuals that are managers, their user profiles would keep their existing attributes and also inherit the attributes of a field technician. The replacement type provides for the overwriting of their attributes. For example, the individuals that are managers, their user profiles would lose their existing attributes and inherit the attributes of a field technician. Although not illustrated, according to other implementations, other elements may be added to graphical user interface 205-6. For example, instead of an all or nothing approach, graphical user interface 205-6 may allow the administrator to see and select the attributes to be inherited. Additionally, or alternatively, the administrator may be able to prevent certain attributes from being overwritten when a replacement type inheritance is selected. Graphical user interface 205-6 also includes an inherit button 720. When the administrator selects inherit button 720, the assignment of attributes is invoked.

According to exemplary an embodiment, a method, a device, a system, and a non-transitory storage medium is described that simplifies the provisioning and management of user profiles of any given system by indicating the identity of the user as a set of properties and properties values rather than indicating the identity of the user by the functions that the user can and cannot do. In other words, for example, it is “who” you are rather than “what” you can do. By defining the “who”—a configurable definition of properties-to-attributes mapping may establish the “what.” End users of the profile management system (e.g., managers, supervisors, etc.) may only have to worry about defining the “who,” while an administrator or an application developer may manage the “what” through the mapping of properties to attributes.

The foregoing description of implementations provides illustration, but is not intended to be exhaustive or to limit the implementations to the precise form disclosed. Accordingly, modifications to the implementations described herein may be possible. For example, the properties and attributes may be used to generate profiles pertaining to anything. For example, with respect to computers used by a business, properties could be directed to the type of computer (e.g., user terminal versus network device) and attributes and attribute values could be directed to the type of software stored on a computer, access rights by individuals, etc. In this regard, although embodiments have been described in relation to “user” profiles, according to other embodiments, the profiles, as described herein, may be generated and directed to any facet of a business, or for that matter, any facet (e.g., business or non-business-related) of which invokes some sort of management.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

In addition, while series of blocks are described with regard to the process illustrated in FIG. 6, the order of the blocks may be modified in other implementations. Further, non-dependent blocks may be performed in parallel. Additionally, with respect to other processes described in this description, the order of operations may be different according to other implementations, and/or operations may be performed in parallel.

The embodiments described herein may be implemented in many different forms of software and/or firmware executed by hardware. For example, a process or a function may be implemented as “logic” or as a “component.” The logic or the component may include, for example, hardware (e.g., processor 505, etc.), or a combination of hardware and software (e.g., software 515). The embodiments have been described without reference to the specific software code since software can be designed to implement the embodiments based on the description herein.

Additionally, embodiments described herein may be implemented as a non-transitory storage medium that stores data and/or information, such as instructions, program code, data structures, program modules, an application, etc. For example, a non-transitory storage medium includes one or more of the storage mediums described in relation to memory/storage 510. The data and/or information may be executed to perform processes or provide functions, as described herein.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded as illustrative rather than restrictive.

In the specification and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

No element, act, operation, or instruction described in the present application should be construed as critical or essential to the embodiments described herein unless explicitly described as such.

What is claimed is:

1. A method comprising:
receiving, by a device, property data that indicates properties of individuals pertaining to employment;
receiving, by the device, property value data that indicates at least one property value for each property;
receiving, by the device, attribute data that indicates attributes of employment pertaining to the individuals and at least one attribute value for each attribute;
receiving, by the device, links between particular instances of the attribute data to particular instances of the property data and particular instances of the property value data;
storing, by the device, the property data, the property value data, the attribute data, and the links;
displaying, by the device, a user interface that allows a user to select properties and property values;
receiving, by the device and via the user interface, user selections of properties and property values that identify an individual, wherein the individuals include the individual;
creating, by the device, a user profile of the individual, wherein the user profile is created based on the user selections and attribute data linked to the user-selected properties and property values; and
using the user profile to govern an employment of the individual.

2. The method of claim 1, wherein the property data of each property and corresponding property value data is stored as a property tree, and the method further comprising:
storing a hierarchical property tree includes each property tree arranged in a hierarchy and linked together.

3. The method of claim 2, wherein the attributes of employment include permissions and non-permissions, and wherein the creating comprises:
creating the user profile based on a bottom-to-top traversal of the hierarchical property tree, wherein the bottom-to-top traversal includes:
traversing leafs of a bottom-most property tree of the hierarchical property tree, wherein the bottom-most property tree represents one of the user-selected properties;
identifying one of the leafs of the bottom-most property tree that corresponds to the user-selected property value;
collecting one or more attributes and one or more attribute values linked to the user selected property value of the one of the leafs;
traversing from the one of the leafs toward a root of the bottom-most property tree;
collecting one or more attributes and one or more attribute values linked to each leaf encountered during the traversing; and
using collected attributes and collected attribute values to create the user profile.

4. The method of claim 3, wherein the creating comprises:
traversing leafs of the other property trees of the hierarchical property tree; and
collecting attributes and attribute values.

5. The method of claim 1, further comprising:
storing user profiles
receiving, by the device, a first user selection of one or more user profiles;
receiving, by the device, a second user selection of one or more other user profiles; and
performing, by the device, an inheritance of attributes from the one or more other user profiles to the one or more user profiles, wherein attributes of the one or more user profiles includes attributes that are different from attributes of the one or more other user profiles.

6. The method of claim 5, wherein the performing comprises:
merging the attributes of the one or more user profiles with the attributes of the one or more other user profiles.

7. The method of claim 5, wherein the performing comprises:
replacing the attributes of the one or more user profiles with the attributes of the one or more other user profiles.

8. The method of claim 1, further comprising:
mapping user profiles with other user profiles pertaining to a particular context; and
allowing a search to identify one of the user profiles pertaining to the particular context.

9. A device comprising:
a communication interface;
a memory, wherein the memory stores instructions; and
a processor, wherein the processor executes the instructions to:
receive property data that indicates properties of individuals;
receive property value data that indicates at least one property value for each property;
receive attribute data that indicates attributes of employment pertaining to the individuals and at least one attribute value for each attribute;
receive links between particular instances of the attribute data to particular instances of the property data and particular instances of the property value data;
store the property data, the property value data, the attribute data, and the links;
provide a user interface that allows a user to select properties and property values;
receive user selections of properties and property values that identify an individual, wherein the individuals include the individual; and
create a user profile of the individual, wherein the user profile is created based on the user selections and attribute data linked to the user-selected properties and property values.

10. The device of claim 9, wherein the property data of each property and corresponding property value data is stored as a property tree, and wherein the processor executes the instructions to:
store a hierarchical property tree includes each property tree arranged in a hierarchy and linked together.

11. The device of claim 9, wherein the attributes of employment include permissions and non-permissions, and wherein the processor executes the instructions to:
receive a link that indicates a dependent relationship between at least one of the properties and the at least one property value to another one of the properties and the at least one property value.

12. The device of claim 9, wherein the processor executes the instructions to:
store user profiles;
receive a first user selection of one or more user profiles;
receive a second user selection of one or more other user profiles; and
perform an inheritance of attributes from the one or more other user profiles to the one or more user profiles, wherein attributes of the one or more user profiles includes attributes that are different from attributes of the one or more other user profiles.

13. The device of claim 12, wherein, when performing, the processor executes the instructions to:
merge the attributes of the one or more user profiles with the attributes of the one or more other user profiles.

14. The device of claim 12, wherein, when performing, the processor executes the instructions to:
replace the attributes of the one or more user profiles with the attributes of the one or more other user profiles.

15. The device of claim 9, wherein the processor executes the instructions to:
map user profiles with other user profiles pertaining to a particular context; and
allow a search to identify one of the user profiles pertaining to the particular context.

16. A non-transitory storage medium storing instructions executable by a computational device, wherein the instructions comprise instructions to:
receive property data that indicates properties of individuals;
receive property value data that indicates at least one property value for each property;
receive attribute data that indicates attributes of employment pertaining to the individuals and at least one attribute value for each attribute;
receive links between particular instances of the attribute data to particular instances of the property data and particular instances of the property value data;
store the property data, the property value data, the attribute data, and the links;
provide a user interface that allows a user to select properties and property values;
receive user selections of properties and property values that identify an individual, wherein the individuals include the individual; and
create a user profile of the individual, wherein the user profile is created based on the user selections and attribute data linked to the user-selected properties and property values.

17. The non-transitory storage medium of claim 16, wherein the property data of each property and corresponding property value data is stored as a property tree, and the non-transitory storage medium further comprising instructions to:
store a hierarchical property tree includes each property tree arranged in a hierarchy and linked together.

18. The non-transitory storage medium of claim 16, wherein the attributes of employment include permissions and non-permissions.

19. The non-transitory storage medium of claim 16, further comprising instructions to:
store user profiles;
receive a first user selection of one or more user profiles;
receive a second user selection of one or more other user profiles; and
perform an inheritance of attributes from the one or more other user profiles to the one or more user profiles, wherein attributes of the one or more user profiles includes attributes that are different from attributes of the one or more other user profiles.

20. The non-transitory storage medium of claim 19, further comprising instructions to:
receive a third user selection of attributes that are designated for the inheritance; and
receive a fourth user selection of attributes that are designated as not to be inherited.
